(19) United States
(12) Patent Application Publication
(10) Pub. No.: US 2025/0067668 A1
(43) Pub. Date: Feb. 27, 2025

(54) APPARATUS AND METHOD FOR MEASURING A SAMPLE

(71) Applicant: Schlumberger Technology Corporation, Sugar Land, TX (US)

(72) Inventors: Timothy Gareth John Jones, Cottenham (GB); Debora Campos de Faria, Cambridge (GB); Nathan Lawrence, Cambridge (GB); Go Fujisawa, Cambridge (GB); Jaroslaw Pulka, Cambridge (GB); Sheng Chao, Cambridge (GB)

(21) Appl. No.: 18/724,320

(22) PCT Filed: Apr. 5, 2023
(86) PCT No.: PCT/US2023/017595

§ 371 Date: Jun. 26, 2024

Related U.S. Application Data
(60) Provisional application No. 63/362,914, filed on Apr. 13, 2022.

(51) Int. Cl. G01N 21/552; G01N 21/35; G01N 21/43

(52) U.S. Cl. CPC G01N 21/552; G01N 21/35; G01N 21/43

(57) ABSTRACT

An apparatus and a method are used for measuring a sample. The apparatus includes a crystal having at least one face in direct contact with the sample, at least one light source emitting and directing at least a first light beam and a second light beam into the same crystal such that the first light beam and the second light beam are totally internally reflected at the interface between the crystal and the sample, and at least one detector detecting the first light beam and the second light beam which have been totally internally reflected at the interface. The first light beam travels along a first optical path in the crystal and the second light beam travels along a second optical path in the crystal, and the first optical path is different from the second optical path in optical property.

### CROSS-REFERENCE TO RELATED APPLICATIONS

The subject disclosure claims priority from U.S. Provisional Appl. No. 63/362,914, filed on Apr. 13, 2022, herein incorporated by reference in its entirety.

### BACKGROUND

The analysis of chemical composition of fluid samples (e.g., from hydrocarbon wells) for the determination of phase behavior and chemical composition can be a critical step in the evaluation of the producibility and economic value of hydrocarbon reserves or other sources of the fluids. Similarly, the monitoring of fluid composition during production, during other operations, or in a laboratory setting can have an important bearing on reservoir or other management decisions.

In the context of hydrocarbon wells, the analysis of specific gases in borehole fluids in the downhole environment using spectral measurements have been proposed. For example, the use of near-infrared transmission spectroscopy can be used to detect methane, ethane, and other simple hydrocarbons in the gas phase, using the absorption of near-infrared radiation.

### BRIEF SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth.

In some embodiments, an apparatus for measuring a sample includes a crystal having at least one face in direct contact with the sample, at least one light source, and at least one detector. Some specific embodiments include the light source as an infrared light source, but an apparatus according to the present disclosure may use one or more other light sources outside of the infrared range, such as visible spectrum light sources, ultraviolet spectrum light sources, or sources with combinations of light source spectra. In some embodiments, a light source may emit and direct at least a first light beam and a second light beam into the same crystal such that the first light beam and the second light beam are totally internally reflected at the interface between the crystal and the sample. The detector may detect the first light beam and the second light beam which have been totally internally reflected at the interface. The first light beam travels along a first optical path in the crystal and the second light beam travels along a second optical path in the crystal, and the first optical path is different from the second optical path in optical property.

In additional one or more embodiments, a method for measuring a sample includes arranging the sample to be in direct contact with at least one face of a crystal and producing and directing a first light beam and a second light beam into the same crystal such that the first light beam and the second light beam are totally internally reflected at an interface between a crystal and a sample. The method can further include detecting the first light beam and the second light beam which have been totally internally reflected at the interface. The first light beam travels along a first optical path in the crystal and the second light beam travels along a second optical path in the crystal, with the first optical path being different from the second optical path in one or more optical properties.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1-1 is a schematic illustration of an apparatus for measuring a sample according to an embodiment of the present disclosure.

FIG. 1-2 is a schematic illustration of an optical path of a first infrared light beam in the apparatus shown in FIG. 1-1.

FIG. 1-3 is a schematic illustration of an optical path of a second infrared light beam in the apparatus shown in FIG. 1-1.

FIG. 2-1 is a schematic illustration of another optical path of a first infrared light beam for an apparatus similar to that shown in FIG. 1-1.

FIG. 2-2 is a chart illustrating internal reflection spectra of a sample using the apparatus of FIG. 2-1.

FIG. 2-3 is a chart illustrating internal reflection spectra of the sample of FIG. 2-2 in a second wavelength range.

FIG. 2-4 is a chart illustrating internal reflection spectra of another sample in a first wavelength range.

FIG. 2-5 is a chart illustrating internal reflection spectra of the sample of FIG. 2-4 in a second wavelength range.

FIG. 3 is a schematic illustration of an apparatus for measuring a sample according to another embodiment of the present disclosure.

FIG. 4 is a schematic illustration of an apparatus for measuring a sample according to a yet another embodiment of the present disclosure.

FIG. 5 is a schematic illustration of an apparatus for measuring a sample according to another embodiment of the present disclosure.

FIG. 6 is a flow diagram of a method for measuring a sample according to an embodiment of the present disclosure.

FIG. 7 is a side view of an apparatus for measuring or detecting at least one property of a sample according to an embodiment of the present disclosure.

FIG. 8 is a side view of an apparatus with multiple light sources for measuring refractive index according to an embodiment of the present disclosure.

FIG. 9 is a schematic illustration of a downhole environment in which a measurement apparatus is used according to an embodiment of the present disclosure.

### DETAILED DESCRIPTION

The ensuing description provides some preferred illustrative embodiments only, and is not intended to limit the scope, applicability or configuration of the inventions covered by the appended claims. Rather, the description will provide those skilled in the art with an enabling description for implementing the claimed inventions. It should be understood that various changes may be made in the function and arrangement of elements without departing from the spirit and scope of the inventions as set forth in the appended claims.

Specific details are given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

In the following description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

It is to be understood that the following description provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and will not in itself dictate a relationship between the various embodiments and/or configurations discussed. Moreover, describing a first feature over or on a second feature includes embodiments in which the first and second features are formed in direct contact, and also includes embodiments in which additional features may be formed interposing the first and second features, such that the first and second features may not be in direct contact.

Generally, aspects of this description relate to sample detection and, more specifically, but not by way of limitation, to devices, methods, and systems for measuring at least one property of a sample. A sample should be understood to be any portion of a material from which the systems and methods described herein collect data. For example, a sample should be understood to include a portion of downhole fluids that are removed from the downhole or field environment and brought to a lab, either on site or off-site, for analysis by any other systems or methods described herein. In other examples, a sample should be understood to include a portion of fluids that are analyzed in situ in the field, a process plant, and/or in the downhole environment.

According to some embodiments, attenuated total reflection (ATR) is used (optionally in the infrared region) for the detection of various analytes. Optionally, these analytes may be relevant to the oil and gas industry. For example, infrared radiation can be used to monitor gases in downhole environments, and infrared radiation used to monitor the concentration of sequestered carbon dioxide dissolved into the liquid solutions of saline aquifers.

In some embodiments, an apparatus for measuring a sample includes a crystal and at least one infrared (IR) light source. The crystal has at least one face arranged and designed to be in direct contact with the sample and the at least one IR light source to emit and direct at least a first infrared light beam and a second infrared light beam into the crystal such that the first infrared light beam and the second infrared light beam are totally internally reflected at the interface between the crystal and the sample. The apparatus can also include at least one detector arranged and designed to detect the first infrared light beam and the second infrared light beam which have been totally internally reflected at the interface, with the first infrared light beam traveling along a first optical path in the crystal and the second infrared light beam traveling along a second optical path in the crystal. The first optical path can be different from the second optical path in optical property. The optical property may include, for example, optical path length, magnitude of incident angle, number of reflections of a light beam in the optical path, etc. As an example, the difference in optical property between the first optical path and the second optical path may allow the first infrared light beam and the second infrared light beam to have different effects on measurements of the sample. For example, a difference in optical property between the first optical path and the second optical path may allow or improve the measurement of different sample properties (e.g., concentration, refractive index, fluid type). A different path length and/or different quantity of internal reflections may allow a different amount of absorption by the sample, which is measured by a detector at the end of the optical path length.

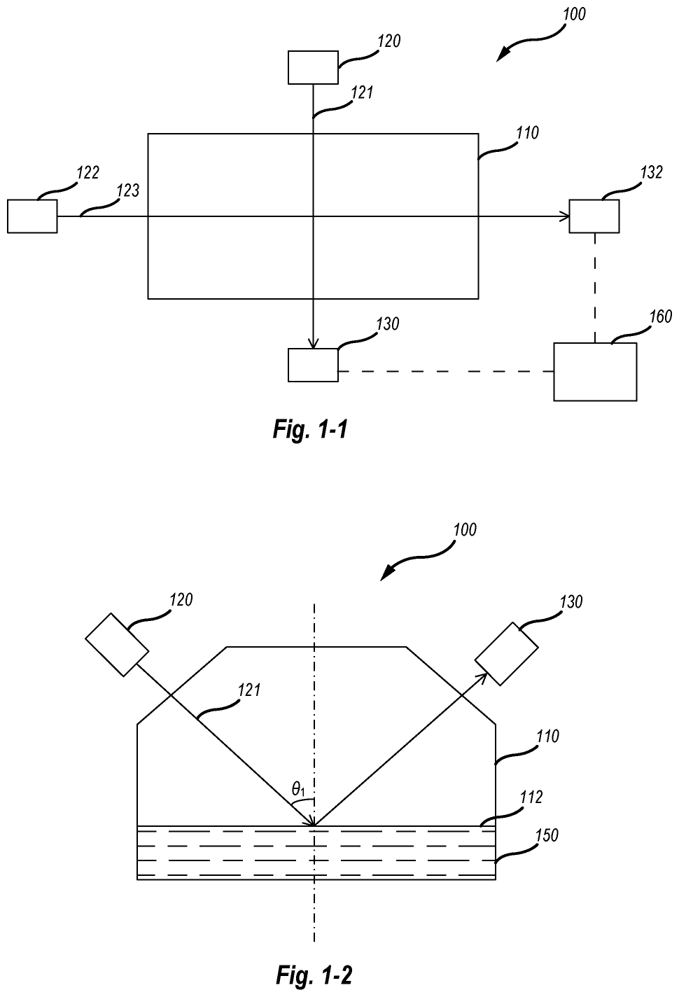

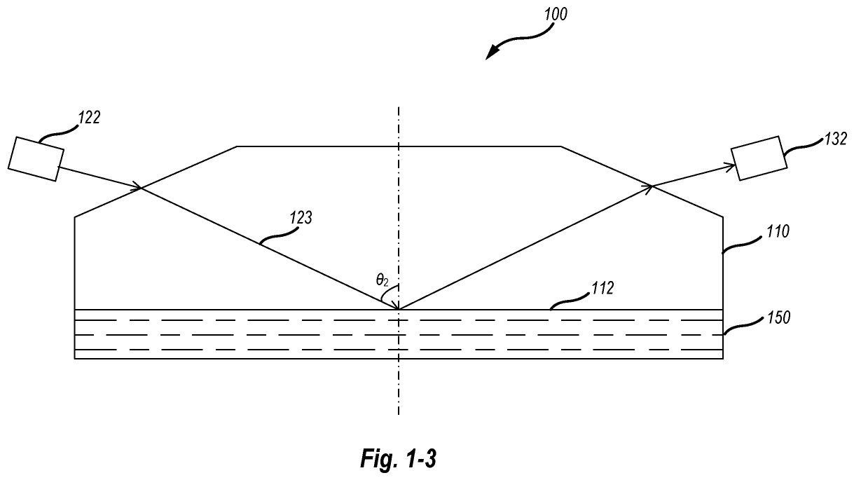

FIGS. 1-1, 1-2, and 1-3 show an example of an apparatus for measuring a sample according to an embodiment of the present disclosure. FIG. 1-1 is a top view of the apparatus 100 and sample. FIG. 1-2 is longitudinal cross-sectional view (showing the path from the first IR light source 120 to the first detector 130) of the apparatus 100 and sample 150. FIG. 1-3 is a transverse cross-sectional view (showing the path from the second IR light source 122 to the second detector 132) of the apparatus 100 and sample 150. In the example, the apparatus 100 includes a crystal 110 which has a face 112 in direct contact with a sample 150 to form an interface between the crystal 110 and the sample 150. As an example, although the face 112 is shown in FIGS. 1-1 and 1-2 as a bottom face, the orientation is purely illustrative, and a face in contact with the sample 150 may be one or more of any faces of the crystal 110, for example, including a bottom face, a top face, a side face, an inclined face, etc.

The apparatus 100 further includes a first IR light source 120, a second IR light source 122, a first detector 130, and a second detector 132. Referring to FIG. 1-1, the first infrared light source 120 and the first detector 130 may provide a first optical path through the crystal 110 and the second infrared light source 122 and the second detector 132 may provide a second optical path through the crystal 110.

As illustrated in FIG. 1-2, a first infrared light beam 121 is emitted from the first infrared light source 120 and directed into the crystal 110. At the interface between the crystal 110 and the sample 150, the first infrared light beam 121 is totally internally reflected. The first detector 130 is arranged to receive the reflected first infrared light beam 121. Referring to FIG. 1-3, a second infrared light beam 123 is emitted from the second infrared light source 122 and directed into the crystal 110. The second infrared light beam 123 is also totally internally reflected at the interface between the crystal 110 and the sample 150 at a different incident angle than the first infrared light beam 121 of FIG. 1-2. The second detector 132 is arranged to receive the totally internally reflected second infrared light beam 123.

As an example, the apparatus 100 may be used to measure a concentration of a component (for example, targeted molecular species such as CO₂, water, liquid hydrocarbons, etc.) in the sample 150, by means of the attenuated total reflection. Referring to FIG. 1-2, if the first infrared light beam 121 is incident on the interface between the crystal 110 and the sample 150 at an angle θ₁ which is equal to or greater than a critical angle θ_{C}, the first infrared light beam 121 will be reflected totally at the interface. In the optical field, and as shown in FIG. 1-2, the critical angle θ_{C} can be measured relative to an axis perpendicular to the interface. The critical angle θ_{C} can be given by the equation:

$${θ}_{C} = {sin}^{- 1} ( {n}_{2} / {n}_{1} ) \qquad [ 1 ]$$

where n₁ is the refractive index of the crystal 110 and n₂ is the refractive index of the sample 150. In order to satisfy the total reflection condition at the interface, the refractive index of the crystal 110 should be greater than that of the sample 150. In an example, the crystal 110 can be made from a high refractive index material with a refractive index greater than 1.5, such as sapphire (n≈1.76) or diamond (n=2.4) in order to reduce the critical angle. Other materials with a high refractive index include cubic zirconia, zinc sulfide, zinc selenide, silicon and germanium. In some examples, water in the fluid has a refractive index of approximately 1.33. Liquid hydrocarbons will have a higher refractive index than water.

It should be noted that the sample 150 may have a uniform refractive index; however, this is not necessary. For example, the sample 150 may have a plurality of components having different refractive indexes. If the components in the sample 150 have different refractive indexes, n₂ will represent the refractive index of the component of the sample 150 in contact with the crystal 110. For instance, if the sample 150 has a plurality of components that can contact the crystal 110, n₂ may be any one of a plurality of refractive indexes.

When the first infrared light beam 121 is totally internally reflected at the interface between the crystal 110 and the sample 150, an evanescent wave will propagate across the interface between the crystal 110 and the sample 150. The evanescent wave will propagate into the sample 150 to a depth (called as “penetration depth”) and will be attenuated due to absorption of the sample 150. The attenuation depends on the component in the sample 150. Thus, the concentration of the component in the sample 150 may be determined by analyzing the absorbance of the reflected first infrared light beam 121 by, for example, analyzing its absorption spectrum.

The relationship between the concentration and the absorbance is given by Beer-Lambert law:

$$A = {\sum }_{i} {ε}_{i} {c}_{i} l \qquad [ 2 ]$$

where A is the absorbance of the sample, εᵢ is the attenuation coefficient of i^{th} component, cᵢ is the concentration of i^{th} component, and l is a path length for absorption. For the attenuated total reflection, the absorption of the sample to the first infrared light beam 121 occurs within the penetration depth. Thus, the path length l depends on the penetration depth. The penetration depth is, for example, given by:

$${d}_{p} = \frac{λ}{2 {π ( {n}_{1}^{2} {sin}^{2} θ - {n}_{2}^{2} )}^{1 / 2}} \qquad [ 3 ]$$

where dₚ is the penetration depth, θ is the incident angle of an infrared light beam (e.g., the first infrared light beam 121 or the second infrared light beam 123) at the interface between the crystal 110 and the sample 150, n₁ is the refractive index of the crystal 110, n₂ is the refractive index of the sample 150, and λ is a wavelength of the infrared light beam. From the above equation [3], it can be seen that the penetration depth dₚ is an increasing function of n₂ and is a decreasing function of the incident angle θ. In other words, assuming that λ and n₁ are constant, if the incident angle θ is constant, the penetration depth dₚ will increase as the refractive index n₂ of the sample 150 increases; otherwise, if the refractive index n₂ is constant, the penetration depth dₚ will decrease as the incident angle θ of the infrared light beam increases.

In the above example of the apparatus 100, two infrared light beams are provided. The first infrared light beam 121 travels along a first optical path in the crystal 110. The second infrared light beam 123 travels along a second optical path different from the first optical path. Between the first and second optical paths, the difference may include an optical property. As an example, the first infrared light beam 121 and the second infrared light beam 123 have a first incident angle θ₁ and a second incident angle θ₂, respectively, at the interface between the crystal 110 and the sample 150. The first incident angle θ₁ may be different from the second incident angle θ₂. Such arrangement can facilitate measuring the concentration of the component in the sample based on the attenuated total reflection. For the measuring based on attenuated total reflection, the sensitivity increases as the absorbance increases and thus increases as the penetration depth increases. Consequently, a large penetration depth is desired to enhance the measuring sensitivity. From the above equation [3], it is seen that the penetration depth is a decreasing function of the incident angle θ. Thus, a small incident angle can also facilitate enhancement of the sensitivity, although the incident angle should be equal to or greater than the critical angle θ_{C} for total internal reflection. The incident angle can, therefore, be selected depending on the refractive index of the component in the sample 150. In the above example of the apparatus 100, the first incident angle θ₁ and the second incident angle θ₂ may be selected for two components respectively to measure two potential components in the sample at the same time. In other examples of the apparatus, additional optical paths may be used with additional, different incident angles, allowing the apparatus to measure additional potential components. Optionally, the apparatus 100 may switch between the first infrared light beam 121 and the second infrared light beam 123 based on their measurement interest and conditions.

TABLE 1

| Incident Angle | | Penetration Depth |
|---|---|---|
| degrees | Species | (dₚ/λ) |
| 53 | Dodecane | unstable |
| | Water | 0.42 |
| 55 | Dodecane | unstable |
| | Water | 0.33 |
| 58 | Dodecane | 0.42 |
| | Water | 0.26 |
| 70 | Dodecane | 0.20 |
| | Water | 0.17 |

Table 1 shows an example for selecting the incident angle for different species in a fluid sample, e.g., from a hydrocarbon well. In the example, the crystal can be made from sapphire having a high refractive index where n₁=1.73. Water can have a refractive index where n₂=1.33 while dodecane can have a refractive index where n₂=1.42. As shown in TABLE 1, the incident angle of 53° may be selected or optimal for the water and can correspond to a maximum penetration depth of 1.27 microns (μm) at a wavelength of 1=3.03 μm, but it can result in an unstable penetration depth for the dodecane, which may produce unreliable data. An incident angle of 58° may be selected or optimal for the dodecane and can correspond to a maximum penetration depth of 1.47 μm at a wavelength of 1=3.42 μm.

The sensor apparatus 100, as well as other apparatus herein (e.g., apparatus 200, 300, 400, or 500) may further include or be coupled to a processer 160 arranged and designed to acquire attenuated intensities of the first infrared light beam 121, the second infrared light beam 123, and any additional infrared light beams detected by the at least one detector 130, 132, and determine concentration of at least one component (e.g., species or phase) in the sample 150. The processer 160 may be in communication with the detectors 130, 132 and collect and process the data (such as absorbance) from the detectors 130, 132. For example, the processor 160 may compare the absorbance extracted from the measurements of the infrared light beams with one or more predetermined values to determine the concentration of at least one component (e.g., species or phase) in the sample 150. The operation of the processer 160 may also be implemented by any known process or processor for deriving the concentration of the component in the sample 150, such as those used in the known ATR-based infrared absorption spectroscopy. As an example, the processor 160 can be used in connection with any of the apparatus 100, 200, 300, 400, 500 described herein, and can include a microprocessor, microcontroller, processor module or subsystem, programmable integrated circuit, programmable gate array, graphics processing unit, or another control, or computing device. In the example views of FIGS. 1-2 and 1-3, the first infrared light beam 121 and the second infrared light beam 123 have a single internal reflection at the interface between the crystal 110 and the sample 150. However, in other embodiments, there may be multiple internal reflections and it is not intended to limit aspects of the present disclosure to a single internal reflection of the first infrared light beam 121 or the second infrared light beam 123 at the interface. As shown in FIG. 2-1, in the apparatus 200, a first infrared light beam 221 may be totally internally reflected at the interface between the crystal 210 and the sample 250 repeatedly. Increasing the number of internal reflections of the first infrared light beam 221 may also increase the path length for absorption for the component in the sample 250. In this way, the measuring sensitivity can be enhanced, particularly if the concentration of the component is low. As an example, the number of internal reflections of the first infrared light beam 221 may be adjusted by changing the shape (e.g., length, aspect ratio) of the crystal 210 and the light emitting direction of the infrared light source 220 relative to the crystal 210. A second infrared light beam (see 123 of FIG. 1-3) may also be totally internally reflected at the interface between the crystal 210 and the sample 250 at multiple times. In one example, the number of internal reflections at the interface for the first optical path is different from the number of internal reflections for the second optical path. It also may provide suitable path lengths for absorption for different optical paths of the light beams, so as to satisfy conditions for measuring various components.

In the above examples, the apparatus 100, 200 are described with reference to its application for measuring chemical species based on ATR. It may be used in (and optionally limited to) an ATR-based mid-infrared region (MIR) absorption spectroscopy. In some embodiments, it may be used outside of the mid-infrared region (2.5 μm to 25 μm) and use near- (750 nm to 2.5 μm) or far-infrared (25 μm to 1.0 mm) light beams. In an embodiment of the present disclosure, one or both of the first infrared light beam 121 or the second infrared light beam 123 are totally internally reflected at the interface between the crystal 110, 210 and the sample 150. In an example, the first incident angle θ₁ of the first infrared light beam 121 at the interface between the crystal 110, 210 and the sample 150, 250 may be greater than the critical angle of internal reflection for the interface. Alternatively, the second incident angle θ₂ of the second infrared light beam 123 at the interface between the crystal 110, 210 and the sample 150, 250 may be greater than the critical angle of internal reflection for the interface. However, it is not intended to limit the apparatus 100, 200 in the application based on ATR. For example, the first infrared light beam 121, 221 and the second infrared light beam 123 may also be reflected at the interface between the crystal 110, 210 and the sample 150, 250 in non-total reflection mode.

The first example is the spectral analysis of a solution of 50 weight percent methanol and 3.5 weight percent of the polymer polyvinylpyrrolidone (PVP) in water. This mixture represents the composition of water produced from a gas well where methanol and PVP have been added as hydrate inhibitors. Methanol is commonly used as thermodynamic hydrate inhibitor and typically used at concentrations in the range 30-60 weight percent, while PVP is a kinetic hydrate inhibitor and usually used at concentrations of less than 5 weight percent.

FIG. 2-2 compares the internal reflection spectra of the solution of methanol and PVP in water in the spectral region 1330-1240 cm⁻¹ (λ=7.519-8.065 μm) collected with 1 and 12 internal reflections with two different optical paths through a crystal such as described in relation to FIG. 2-1. This spectral region shows the so-called amide III absorption bands of PVP, which includes or consist of bands at 1294 and 1278 cm⁻¹ (λ=7.728 and 7.825 μm).

The absorbance of the band at 1294 cm⁻¹, relative to the local minimum in the absorbance at 1247 cm⁻¹, is 0.096 for 12 internal reflections and 0.008 for 1 internal reflection. The larger number of internal reflections enables the PVP to be quantified more accurately and for a lower limit of detection to be achieved.

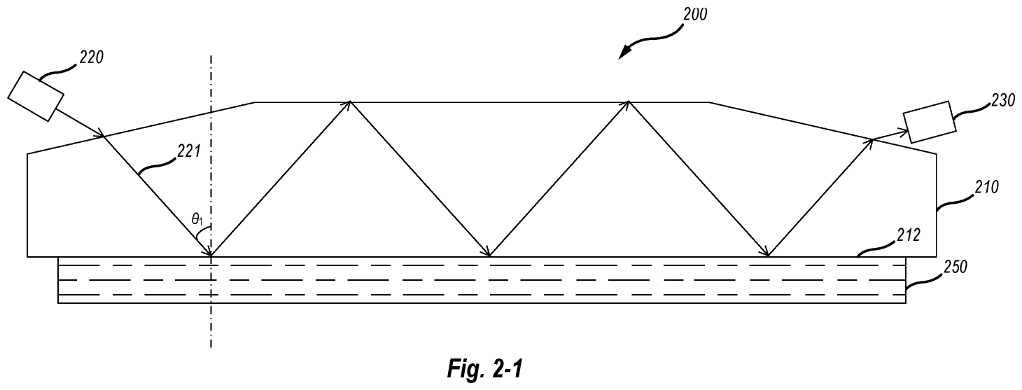

FIG. 2-3 shows the corresponding comparison of the spectra in the spectral range 1080-950 cm⁻¹ (λ=9.259-10.526 μm). The absorbance band at 1013 cm⁻¹, due to C—O stretching, is the most intense band in the spectrum of methanol and the preferred band for quantification. However, with 12 reflections the absorbance is greater than 2.5, which results in only approximately 0.3% of the intensity of the radiation reaching the detector. With only 1reflection the peak absorbance is 0.30, which corresponds to 50% of the radiation reaching the detector and therefore a significantly higher signal-to-noise ratio for quantitative analysis.

The second example shows the spectral analysis of a solution of 50 weight percent ethylene glycol in water that is saturated with dissolved carbon dioxide at a partial pressure of 1 bar. The mixture of water, ethylene glycol and carbon dioxide could represent either the produced water from a gas well treated with hydrate inhibitor or a liquid coolant, both of which have been exposed to a low partial pressure of carbon dioxide.

FIG. 2-4 compares the internal reflection spectra of the solution of ethylene glycol and carbon dioxide in water in the spectral region 2370-2310 cm⁻¹ (λ=4.219-4.329 μm) collected with 1 and 12 internal reflections. The single peak at 2341 cm⁻¹ is due to dissolved carbon dioxide and the peak absorbance values, relative to the local minimum in the absorbance at 2324 cm⁻¹, are 0.027 and 0.004. The larger number of internal reflections enables the dissolved carbon dioxide to be quantified more accurately and lower limits of detection to be achieved.

FIG. 2-5 shows the corresponding comparison of the internal reflection spectra in the spectral range 1125-975 cm⁻¹ (λ=8.889-10.256 μm). The peak absorbance values of the bands at 1084 and 1039 cm⁻¹ are in excess of 2 and therefore less than 1% the intensity of the radiation reaching the detector. In contrast, the peak absorbance values achieved with only 1 reflection are in the range 0.20-0.25 and 56-63% of the intensity of the radiation reaching the detector. The signal-to-noise ratio is significantly greater with the spectrum collected with 1 reflection, which will result in a more reliable determination of the concentration of ethylene glycol.

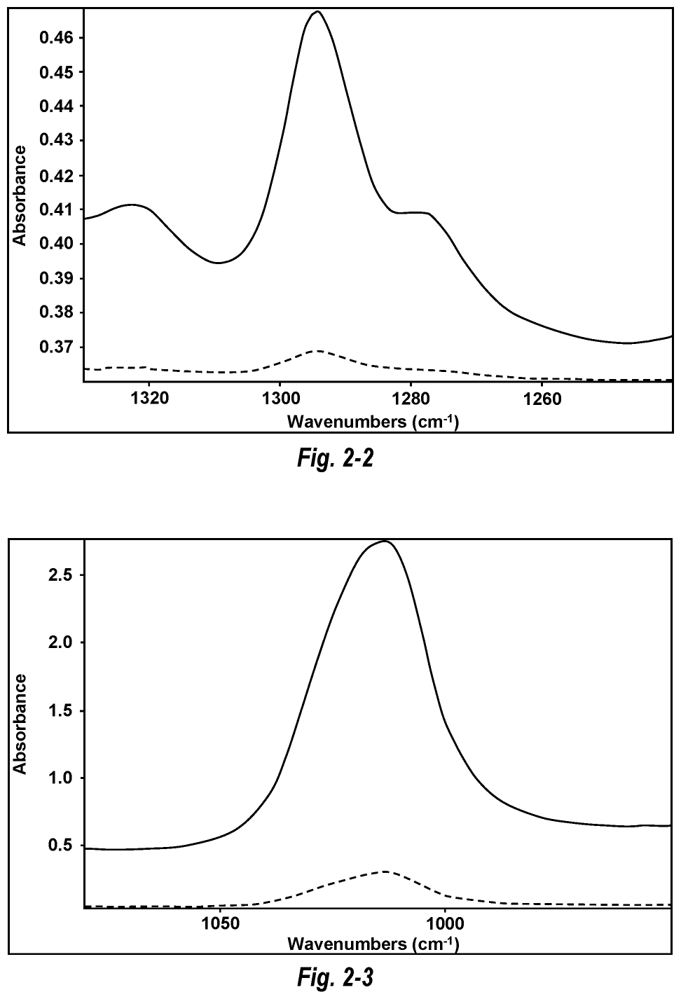

In an embodiment, the apparatus 100, 200 may further include an optical deflection device in the first optical path or the second optical path. The optical deflection device may deflect the first infrared light beam 121, 221 or the second infrared light beam 123, such that the first infrared light beam 121, 221 or the second infrared light beam 123 can be directed into the crystal 110, 210 along any desired direction. As an example, the optical deflection device may include a plurality of reflectors (see reflectors 341, 342, 343, 344 of FIG. 3 and reflectors 441, 442 of FIG. 4).

FIG. 3 and FIG. 4 show examples of example apparatus 300, 400 for measuring a sample according to another embodiment of the present disclosure. The first infrared light beam 321, 421 and the second infrared light beam 323, 423 can be emitted by the same infrared light source 320, 420. As an example, the infrared light source 320 may emit two separate infrared light beams to form the first infrared light beam 321 and the second infrared light beam 323, as illustrated in FIG. 3. Alternatively, the infrared light source 420 may include a beam splitter 428 which splits a single infrared light beam 426 into the first infrared light beam 421 and the second infrared light beam 423, as shown in FIG. 4. For example, the beam splitter 428 may transmit a part of the single infrared light beam 426 as the first infrared light beam 421 and reflect the other part of the single infrared light beam 426 as the second infrared light beam 423. The beam splitter 428 may have any of a variety of configurations and may be, for instance, a half transparent mirror, a polarizing beam splitter, or any other suitable beam splitter. As an example, the single infrared light beam 426 may be emitted from a light emitting component 427, such as a laser, a xenon lamp, or a filament lamp.

In FIG. 3, the first infrared light beam 321 and the second infrared light beam 323 which have been reflected at the interface are detected by the same detector 330. Alternatively, as shown in FIG. 4, the first infrared light beam 421 and the second infrared light beam 423 emitted from the same infrared light source 420 and reflected at the interface may be detected by the first detector 430 and the second detector 432 respectively.

While two infrared light beams are shown in the example embodiments of FIGS. 1-1 to 2-1 and of FIGS. 3 and 4, the number and type of light beams are not limited to only two or two infrared spectra in the present disclosure. For example, at least one light source may further emit and direct at least one additional infrared or other spectra of light beam other than the first infrared light beam and the second infrared light beam, into the same crystal such that the at least one additional light beam is reflected at the interface between the crystal and the sample. At least one detector of the apparatus may further detect the at least one additional light beam which has been totally internally reflected at the interface. Any or each of the at least one additional light beam can travel along an additional optical path other than the first optical path and the second optical path. The additional optical path may have a different number of internal reflections or a different incident angle from those of the first optical path and the second optical path or have a different number of internal reflections and a different incident angle from those of the first optical path and the second optical path. The additional light beam can provide additional selections for measuring the species in the sample. In some embodiments, the one or more additional light beams are in the mid-infrared region.

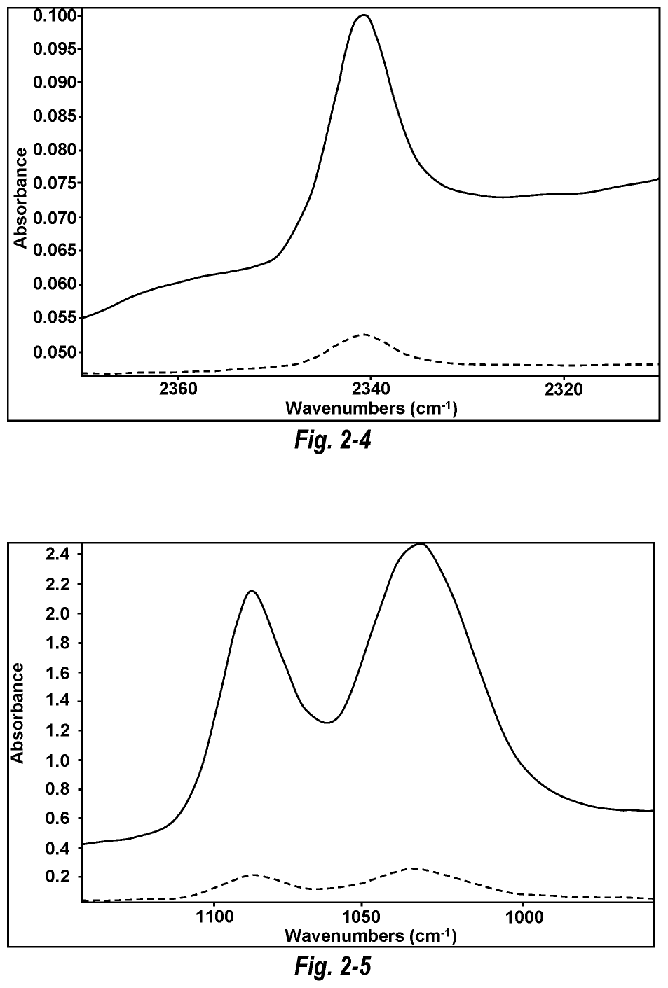

As shown in FIG. 5, an additional infrared light beam 525 is emitted from an additional infrared light source 524 and received by an additional detector 534 after it is totally internally reflected at the interface. However, alternatively, the additional infrared light beam 525, the first infrared light beam 521, and the second infrared light beam 523 may be emitted from the same infrared light source 520 and/or received by the same detector 530 after they are totally internally reflected at the interface. For example, if the sample comes from multiphase downhole environments, it may include an oil phase, a water phase, and a gas phase. The first infrared light beam 521, the second infrared light beam 523, and the additional infrared light beam 525 may measure the concentration of the three phases respectively. In such an embodiment, there may be any number (such as one, two, or more) of the additional infrared light beam 525.

In some embodiments of the present disclosure, the crystal may have a shape adapted for the arrangement of the infrared light beams. For example, as illustrated in FIG. 1-1, when two infrared light beams are provided, the crystal 110 optionally has a rectangular shape in a plan view. In another example, as illustrated in FIG. 5, when three infrared light beams are provided, the crystal 510 optionally has a hexagonal shape in a plan view.

In some embodiments of the present disclosure, each of the first infrared light beam (e.g., 121, 221, 321, 421, 521) and the second infrared light beam (e.g., 123, 323, 423, 523) has a wavelength in a range of 0.4 μm to 15 μm, for example 2.5 μm to 8 μm. In addition, the additional infrared light beam 525 may also have a wavelength in a range of 0.4 μm to 1.0 mm, for example 2.5 μm to 8 μm. However, the above numerical values are given only by way of examples, instead of limiting the wavelength of the infrared light beams in the present disclosure.

In some embodiments of the present disclosure, the sample (e.g., sample 150, 250) may be any available sample, including a solid sample, a liquid sample, or a gas sample. Alternatively, the sample may also be a mixture of two or more of a solid, liquid, or gas, for example, the sample may be a fluid sample from a hydrocarbon well. The fluid sample may be homogenous or may be non-homogenous.

In some embodiments of the present disclosure, any one or more light sources, including a first infrared light source, second infrared light source, additional infrared light sources, or combinations thereof, may be any known infrared light source, including a laser, a xenon lamp, or a filament lamp. In the embodiment of the present disclosure, any detector, including a first detector, a second detector, or an additional detector may be any known detector for detecting a light with an infrared wavelength.

In some embodiments of the present disclosure, the number of the infrared light sources is not intended to be limited, for example, there may be one, two, three, or more infrared light sources in the apparatus. Similarly, in the embodiments of the present disclosure, the number of the detectors is not intended to be limited, for example, there may be one, two, three or more detectors in the apparatus.

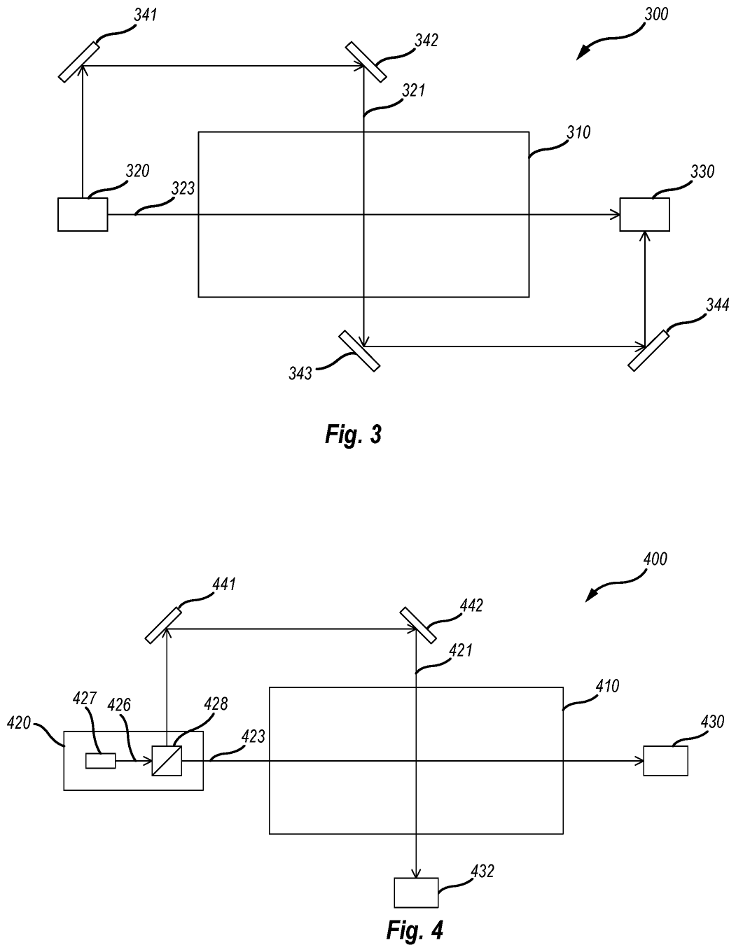

Embodiments of the present disclosure also provide methods for measuring a sample. For instance, the method 670 illustrated in FIG. 6 includes arranging a sample to be in direct contact with at least one face of a crystal at step 672. As discussed herein, the sample may include one or more of liquid, solid, or gas components, and may be contacted against any suitable surface, including a top, bottom, side, or other surface of the crystal. With the sample in contact with the face of the crystal, and at step 674, first and second infrared light beams are produced and directed into the crystal, thereby causing the first and second infrared light beams to totally internally reflect at an interface between the crystal and the sample. The light may be produced by any suitable light source and may be directed at a suitable incident angle, which is greater than the critical incident angle to produce total internal reflection.

At step 676, the first infrared light beam and the second infrared light beam that have been totally internally reflected at the interface can be detected. In some embodiments, the first infrared light beam travels along a first optical path in the crystal and the second infrared light beam travels along a second optical path in the crystal, and the first optical path is different from the second optical path in at least one optical property. In a further embodiment, the first infrared light beam and the second infrared light beam may have different incident angles at the interface and/or different number of internal reflections in the crystal. Detecting the first and second infrared light beams at 676 may also include determining properties or features of the sample based on the totally internally reflected first and second infrared light beams with the first and second optical paths, respectively. For instance, as discussed herein, the penetration depth, absorbance of the totally internally reflected first and second infrared light beams, or component concentration may be determined from detecting the first infrared light beam and second infrared light beam.

In the embodiments of the present disclosure, more than one infrared light beam is provided and multiple optical paths can be designed for measuring different components in the sample in contact with the sensor apparatus. In this way, the measuring sensitivity of the respective components can be improved. This can be especially desirable if the sample includes multiple phases. By means of the apparatus and method according to the present disclosure, not only the concentration of a single component may be determined, but also the concentrations of multiple components in the sample may be determined together.

As described herein, such as in relation to equation [1], the index of refraction of the material impacts the measurements of absorption and optical properties used to calculate the spectral analysis. The refractive index and the concentration of one or more analytes can be obtained simultaneously by measuring the total internal reflection of the same sample using a suitable bi-directional internal reflection window through which light can pass in more than one direction or any of the configurations described herein with more than one angle of incidence. In some embodiments, a single set of a source and detector can be used while rotating or otherwise moving the internal reflection window to create different optical directions through the window. The refractive index of the analyte is an important parameter in determining the effective optical path length of the radiation in the sample of the analyte and the measurement of the concentration of components in the analyte using the Beer-Lambert law. The refractive index is a property of a fluid which can be well correlated to fluid types (e.g.: hydrocarbons) and mixtures of fluids (e.g.: glycol-water mixtures), and therefore could be used for fluid discrimination and for the quantification of binary mixtures.

The refractive index can be determined for the sample or components of the sample by measurement of a critical angle (as the critical angle is dependent on the refractive index) and/or by measuring absorption at two or more different angles of incidence. The critical angle can be measured by directing a source light at the sample through the window at a plurality of incident angles. For example, a source and a detector may be positioned on opposite sides of the window and moved relative to the sample surface of the window using a goniometer. The source S₁ and detector D₁ are rotated to various angles of incidence θ to determine the smallest value of θ at which radiation is detected by D₁. The smallest angle of θ is the critical angle θ_{C} and the refractive index n₂ of the sample is given by the product n₁sinθ_{c}. In other embodiments, the crystal is rotated or moved relative to the source S₁ and detector D₁.

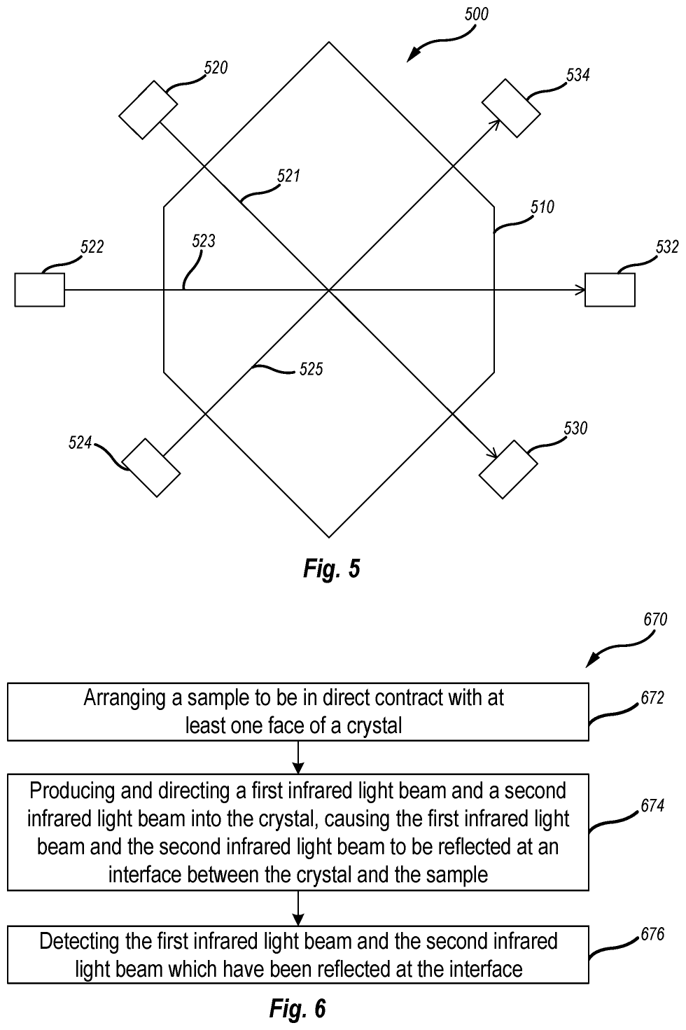

In some applications, it may not be practical to use a goniometer, which requires movement of the source and detector, to measure the refractive index of samples. For example, the refractive index measurement may be required for process applications where high frequency (near continuous) measurements are required and where space and access to the measurement are limited. The moving parts in the refractive index measurement can add significantly to the cost of the measurement and to the need for maintenance and regular calibration. FIG. 7 shows a schematic representation of a system 700 for measuring or otherwise detecting a property (e.g., the refractive index) of a material 750 by means of measuring the critical angle θ_{C}. In FIG. 7, the system 700 can include no moving parts, and can thus include a fixed source and detector 730 (or at least a source and detector 730 in fixed position relative to each other and a lens 740). In this embodiment, a convex lens 740 is used to focus the rays from the source onto the curved surface of the window such that the angle at which each beam meets the curved surface is close to 90° (i.e., normal incidence). A mask can be placed on the lens 740 to restrict radiation and attempt to ensure that radiation is limited outside the plane of the linear array detector 730, with the radiation inside the plane of the linear array detector 730 passing into the internal reflection window. The use of a narrow slit of incident radiation and a linear array detector 730 allows for multiple sources and detectors 730 to be located along the axis of the window to enable multiple measurements to be made concurrently.

The radiation totally internally reflected by the window is detected by the linear array detector 730, which includes or consists of a line of equally spaced detectors of length Δ_{D}. For measurements of refractive index made in the visible spectral region, the array can include or consist of charged coupled device (CCD) detectors, while for measurements in the near-infrared spectral region the array detector 730 can include or consist of indium gallium arsenide photodetectors. The measurement of refractive index in the mid-infrared spectral region can be achieved using a linear array of thermal detectors, such as bolometers or mercury cadmium telluride (MCT) photoconductive detectors.

The linear array, in some embodiments, forms the arc of a circle of radius (r+L) that is optionally concentric to the arc of the circle that forms the curved surface of the bi-directional window (r) and at a distance L from it. The angle θ (in degrees) of the radiation totally internally reflected by the bi-directional window is given by

$$θ = {θ}_{o} + \frac{57.296 {m}_{i} {Δ}_{D}}{( r + L )} \qquad [ 4 ]$$

where θₒ is the minimum value of θ that can be detected by the detector array and mᵢ is the number of the detectors in the linear array at which radiation is detected. Alternatively, the relationship between θ and mᵢ can be obtained by calibration using, for example, a goniometer. The critical angle θ_{C} is the value of θ corresponding to the smallest value of i in the linear array of detectors mᵢ.

The refractive index may also be measured by observing a change in the penetration depth dₚ of the totally internally reflected radiation with the angle of incidence θ. The depth of penetration dₚ of the evanescent wave into the sample at the condition of total internal reflection is given by equation [3].

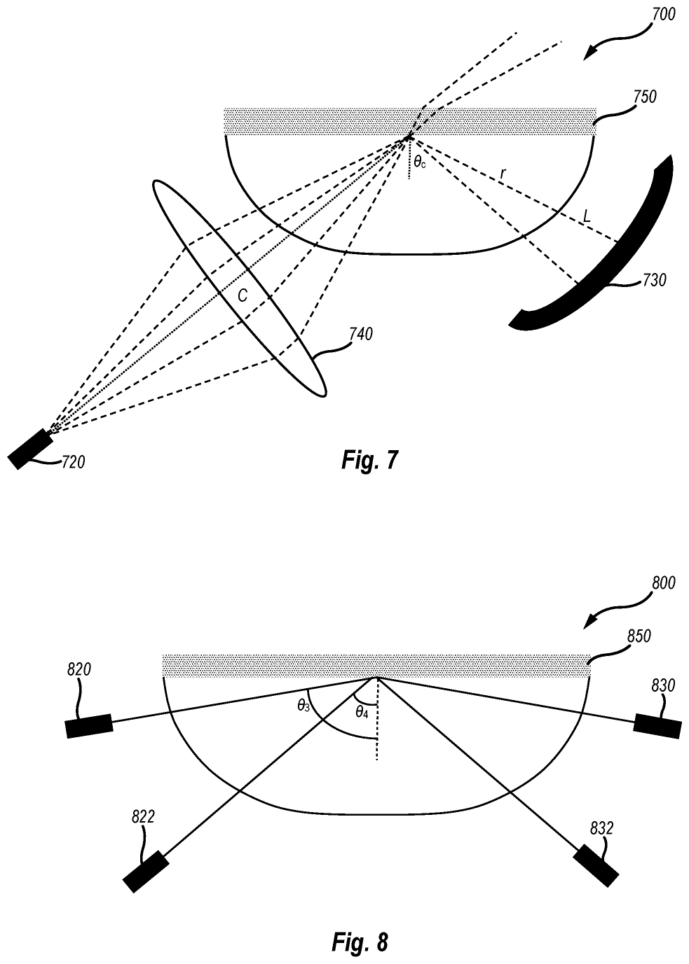

FIG. 8 is an example of a system 800 for the measurement of the refractive index of a material 850 measuring the absorbance of the material 850 at the condition of total internal reflection using two different angles (θ₃ and θ₄) and at the same wavelength λ.

For each angle 74 ᵢ, the absorbance Aᵢ, defined as by

$${A}_{i} = - log ( \frac{{I}_{i}}{{I}_{o i}} ) \qquad [ 5 ]$$

where Iₒᵢ and Iᵢ are the intensities measured by detector Dᵢ at angle of incidence θᵢ (>θ_{C}) in the absence and presence of the sample, respectively. The wavelength at which the measurement of Iₒᵢ and Iᵢ are made is fixed.

In some embodiments, it is not practical to measure Iₒᵢ in the absence of the sample, such as the case of an on-line measurement where the internal reflection window is in contact with the sample for long time periods of time. Iₒᵢ can be determined by splitting part of the beam from the source before it enters the window. It may be desirable to combine sources 820, 822 into a single source and use an optical conduit, such as an optical fiber or a light pipe, to transmit the radiation from the single source to the window.

Radiation from the single combined source may be diverted into three optical fibers by means of condensers and propagated into a reference detector 830, 832 and into the internal reflection window at locations 820, 822 shown in FIG. 8. If the combined source is a broad band source, then the radiation may be transmitted through narrow bandpass filters before entering the optical fibers to the reference detector and to the source locations 820, 822 to ensure the measurement of absorption and hence refractive index are made at the same wavelength.

The absorbance Aᵢ for a particular pair of sources Sᵢ (e.g., 820, 822) and detectors Dᵢ (e.g., 830, 832) can be given by:

$${A}_{i} = - log ( \frac{{I}_{1}}{{α}_{i} {I}_{o}} ) \qquad [ 6 ]$$

where Iᵢ is the intensity of the radiation totally internally reflected at the sample-window interface measured by detector Dᵢ and αᵢ is the multiple of the reference intensity Iₒ measured by detector Dᵢ in the absence of any sample. The values of αᵢ can be determined before the deployment of the refractive index measurement and should remain constant in the absence of degradation of the optical fibers or the window. The values of αᵢ are preferably close to unity but can be smaller or greater than unity.

The absorbance Aᵢ is expected to be directly proportional to the penetration depth dₚᵢ since the penetration depth is proportional to the effective optical path length of the totally internally reflected radiation in the sample. Aᵢ and dₚᵢ can be related by:

$${A}_{i} = k {d}_{p i} \qquad [ 7 ]$$

where k is a constant. The ratio of the absorbance values A₃ and A₄, measured at angles of incidence θ₃ and θ₄ and at the same wavelength λ, is given by:

$$\frac{{A}_{3}}{{A}_{4}} = {R}_{A} = {( \frac{[ {sin}^{2} {θ}_{4} - {sin}^{2} {θ}_{c} ]}{[ {sin}^{2} {θ}_{3} - {sin}^{2} {θ}_{c} ]} )}^{1 / 2} \qquad [ 8 ]$$

with dₚᵢ given by equation [3]. Rearrangement of equation [8] gives:

$${sin}^{2} {θ}_{c} = \frac{{sin}^{2} {θ}_{4} - {R}_{A}^{2} {sin}^{2} {θ}_{3}}{( 1 - {R}_{A}^{2} )} \qquad [ 9 ]$$

or, with sinθ_{C}=n₂/n₁,

$${n}_{2} = {{n}_{1} [ \frac{{sin}^{2} {θ}_{4} - {R}_{A}^{2} {sin}^{2} {θ}_{3}}{( 1 - {R}_{A}^{2} )} ]}^{1 / 2} \qquad [ 10 ]$$

The values of θ₃ and θ₄ can be chosen to be as far apart as possible or practical to yield as large a contrast in A₃ and A₄ as possible or practical. For example, the value of θ₄ can be made to approach the critical angle θ_{C} to increase the values dₚ₄ and A₄.

As described in relation to equations [1] and [3], the path length and absorption are partially dependent on the value of n₂. The direct measurement of n₂ can, therefore, be made from a plurality of simultaneous and stationary measurements to further refine the accuracy of the systems and methods described herein.

In the present disclosure, embodiments can be practiced using a computing device or other processor included in a sensor apparatus, in communication with a sensor apparatus, or which receives data from a sensor apparatus. Data and instructions are stored in respective storage devices and are implemented as one or multiple computer-readable or machine-readable media and may be part of or separate from the processor. Computer-readable storage media includes different forms of memory/storage including: semiconductor memory devices such as dynamic or static random access memories (DRAMs or SRAMs) erasable and programmable read-only memories (EPROMs), electrically erasable and programmable read-only memories (EEPROMs) and flash memories; magnetic disks such as fixed, floppy, and removable disks; other magnetic media including tape; optical media such as compact disks (CDs) or digital video disks (DVDs); other types of storage devices; or combinations of the foregoing. Note that the instructions discussed above can be provided on one computer-readable or machine-readable storage medium, or alternatively, can be provided on multiple computer-readable or machine-readable storage media, including media distributed in a large system having possibly plural nodes that are local or remote from each other.

Computer-readable or machine-readable storage media are considered to be part of an article or article of manufacture. An article or article of manufacture can refer to any manufactured single component or multiple components. The storage medium or media can be located either in the machine running the machine-readable instructions or located at a remote site from which machine-readable instructions can be downloaded over a network for execution. Storage media is a particular type of computer-readable or machine-readable media. For instance, computer-readable transmission media can include carrier waves or wireless connections. Transmission media is distinct from storage media but can be used individually or collectively as computer-readable or machine-readable media.

The devices, systems, and methods described herein may be used in a downhole environment, in a surface field setting, in a process plant, or in a remote lab, such as a benchtop analysis, to determine the composition of a sample. In some embodiments, the devices, systems, and methods described herein may be employed in one or more locations in downhole environment to evaluate the drilling fluids or other fluids introduced to the downhole environment or produced in the downhole environment in real-time. In some embodiments, the devices, systems, and methods described herein may be employed in one or more locations in downhole environment to evaluate the drilling fluids or other fluids introduced to the downhole environment or produced in the downhole environment in a laboratory. In some embodiments, the devices, systems, and methods described herein may be employed in one or more locations in downhole environment to evaluate environmental fluids, such as monitoring seawater during drilling operations. In some embodiments, the devices, systems, and methods described herein may be employed in one or more locations in downhole environment to evaluate fluids during non-hydrocarbon drilling, such as geothermal wellbore drilling.

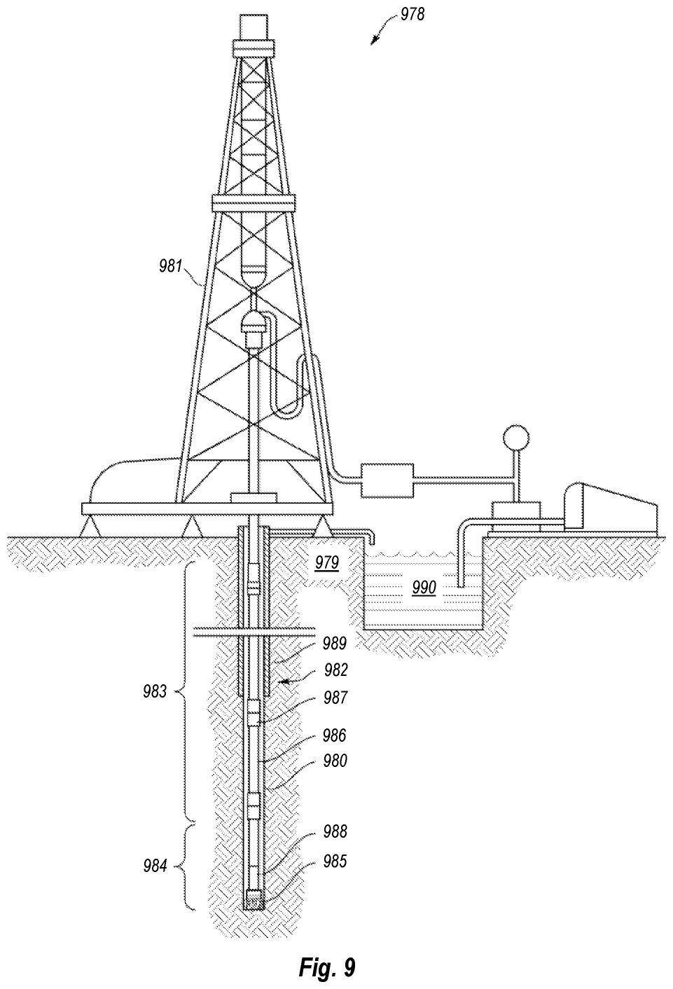

FIG. 9 shows one example of a drilling system 978 for drilling an earth formation 979 to form a wellbore 980. The drilling system 978 includes a drill rig 981 used to turn a drilling tool assembly 982 which extends downward into the wellbore 980. The drilling tool assembly 982 may include a drill string 983, a bottomhole assembly (BHA) 984, and a bit 985, attached to the downhole end of drill string 981. A drilling system 978 according to the present disclosure may produce or introduce materials into the drilling fluid in the downhole environment, and systems and methods described herein may allow analysis of the fluids produced during drilling operations.

The drill string 981 may include several joints of drill pipe 986 connected end-to-end through tool joints 987. The drill string 983 transmits drilling fluid through a central bore and transmits rotational power from the drill rig 981 to the BHA 984. In some embodiments, the drill string 983 may further include additional components such as subs, pup joints, etc. The drill pipe 986 provides a hydraulic passage through which drilling fluid is pumped from the surface. The drilling fluid discharges through selected-size nozzles, jets, or other orifices in the bit 985 for the purposes of cooling the bit 985 and cutting structures thereon, and for lifting cuttings out of the wellbore 980 as it is being drilled.

The BHA 984 may include the bit 985 or other components. An example BHA 984 may include additional or other components (e.g., coupled between the drill string 983 and the bit 985). Examples of additional BHA components include drill collars, stabilizers, measurement-while-drilling (MWD) tools, logging-while-drilling (LWD) tools, downhole motors, underreamers, section mills, hydraulic disconnects, jars, vibration or dampening tools, other components, or combinations of the foregoing.

In general, the drilling system 978 may include other drilling components and accessories, such as special valves (e.g., kelly cocks, blowout preventers, and safety valves). Additional components included in the drilling system 978 may be considered a part of the drilling tool assembly 982, the drill string 983, or a part of the BHA 106 depending on the locations of the components in the drilling system 100.

The drilling system 978 may include one or more downhole motors 988 in addition to or as an alternative to a surface component, such as a top drive in the rig 981. The downhole motors 988 can include turbodrills, progressive displacement motors (PDMs), other mud motors driven by the drilling fluid, electric motors, or other motors positioned downhole of the surface. The downhole motors 988 are capable of providing torque to the bit 985 to remove material from the formation 979. For example, a PDM mud motor is driven by the fluid pressure of drilling fluid pumped downhole through the drill string 983 that is urged through a series of cavities in the PDM mud motor to rotate a rotor of the PDM mud motor. The rotation of the rotor converts the downhole pressure of the drilling fluid to torque to rotate the bit 985. Turbodrills operate by rotating a turbine with a flow of drilling fluid past the turbine. The rotation of the turbine, in turn, rotates the drill bit relative to the drill string.

The bit 985 in the BHA 984 may be any type of bit suitable for degrading downhole materials. For instance, the bit 985 may be a drill bit suitable for drilling the earth formation 979. Example types of drill bits used for drilling earth formations are fixed-cutter or drag bits, roller cone bits, or hybrids of fixed and roller cone bits. In other embodiments, the bit 985 may be a mill used for removing metal, composite, elastomer, other materials downhole, or combinations thereof. For instance, the bit 985 may be used with a whipstock to mill into casing 989 lining the wellbore 980. The bit 985 may also be a junk mill used to mill away tools, plugs, cement, other materials within the wellbore 980, or combinations thereof. Swarf or other cuttings formed by use of a mill may be lifted to surface or may be allowed to fall downhole.

As described herein, devices, systems, and methods according to the present disclosure may be used to measure sample fluids and suspensions from any location in the drilling system 978. For example, embodiments of systems and methods according to the present disclosure may measure absorption and/or compositions of samples of drilling fluid from the BHA 984, the drill string 983 (e.g., in the drill pipe 986), outside of the drill string 983 in the wellbore 980, formation fluids that enter the wellbore 980 from the formation 979, or surface fluids such as taken from reservoirs 990. In some embodiments, a measurement device (such as apparatus 100, 200, 300, etc. described herein) is positioned in the downhole environment to measure the fluids. For example, a measurement device may be positioned in the BHA 984 or in the drill string 983.

Embodiments described herein are given by way of example and are not intended to limit the present disclosure beyond what is recited in the claims. For instance, FIG. 9 describes a drilling system useful in the exploration or production/extraction of natural resources, and apparatus and methods described herein can be used in connection with such a system, including in downhole or surface components of the system. In other embodiments, materials (e.g., drilling fluids, production fluids, natural resources, etc.) that are intended for use with a drilling or other natural resource exploration or production system, or extracted using such a system, may be used in connection with apparatus and methods of the present disclosure in other environments (e.g., laboratory, manufacturing, research and development, etc.). In still other embodiments, apparatus and methods of the present disclosure can be used in still other environments and industries that may have no connection to the exploration or production of natural resources. Examples of such industries include industries where determining purity, pollution, or contamination are used (e.g., air/water quality, emissions monitoring, leak detection, food and drink quality, health and beauty product quality, etc.), breath/blood/saliva analysis, security tools (e.g., material sensors), cryogenics, and other industries where determination of the content or presence of a material may be useful.

Thus, while the principles of the disclosure have been described above in connection with specific apparatuses and methods, it is to be clearly understood that this description is made only by way of example and not as limitation on the scope of the invention. Further, while in the foregoing description, numerous details are set forth to provide an understanding of the subject disclosed herein, implementations may be practiced without some of these details. Other implementations may include modifications and variations from the details discussed herein. It is intended that the appended claims cover such modifications and variations.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A sensor apparatus, comprising:
a crystal having at least one face arranged and designed to be in direct contact with a sample;
at least one light source arranged and designed to emit and direct at least a first light beam and a second light beam into the crystal such that the first light beam and the second light beam are totally internally reflected at the interface between the crystal and the sample, with the first light beam travelling along a first optical path in the crystal and the second light beam travelling along a second optical path in the crystal, the first optical path being different from the second optical path in at least one optical property; and
at least one detector configured to detect the first light beam and the second light beam which have been reflected at the interface.

2. The apparatus of claim 1, at least one of the first light beam and the second light beam being totally internally reflected at the interface between the crystal and the sample.

3. The apparatus of claim 2, both of the first light beam and the second light beam being totally internally reflected at the interface between the crystal and the sample.

4. The apparatus of claim 1, the first light beam and the second light beam having a first incident angle and a second incident angle at the interface, respectively, the first incident angle not being equal to the second incident angle.

5. The apparatus of claim 4, the first incident angle being greater than a critical angle of reflection for the interface between the crystal and the sample.

6. The apparatus of claim 1, the sample being a fluid sample from a hydrocarbon well.

7. The apparatus of claim 1, the number of internal reflections at the interface in the first optical path being different from the number of internal reflections at the interface in the second optical path.

8. The apparatus of claim 1, further comprising:
at least one optical deflection device in the first optical path or the second optical path.

9. The apparatus of claim 8, the at least one optical deflection device including a plurality of reflectors.

10. The apparatus of claim 1, the at least one light source including a single light source arranged and designed to emit both the first light beam and the second light beam.

11. The apparatus of claim 10, the single light source further including a beam splitter arranged and designed to split a single light beam into the first light beam and the second light beam.

12. The apparatus of claim 1, the at least one light source including a first light source which emits the first light beam and a second light source which emits the second light beam.

13. The apparatus of claim 1, the at least one detector including a single detector that detects the first light beam and the second light beam which have been totally internally reflected at the interface.

14. The apparatus of claim 1, the at least one detector including a first detector which detects the first light beam and a second detector which detects the second light beam.

15. The apparatus of claim 1, the at least one light source being arranged and designed to further emit and direct at least one additional light beam other than the first light beam and the second light beam into the crystal, such that the at least one additional light beam is totally internally reflected at the interface between the crystal and the sample, and the at least one detector being arranged and designed to detect the at least one additional light beam which has been totally internally reflected at the interface,
wherein the at least one additional light beam travels along an additional optical path other than each of the first optical path and the second optical path, the additional optical path having a different number of reflections as compared to the first optical path and the second optical path.

16. The apparatus of claim 1, the at least one light source being arranged and designed to further emit and direct at least one additional light beam other than the first light beam and the second light beam into the crystal, such that the at least one additional light beam is totally internally reflected at the interface between the crystal and the sample, and the at least one detector being arranged and designed to detect the at least one additional light beam which has been totally internally reflected at the interface,
wherein the at least one additional light beam travels along an additional optical path other than each of the first optical path and the second optical path, the additional optical path having a different incident angle as compared to the first optical path and the second optical path.

17. The apparatus of claim 1, each of the first light beam and the second light beam having a wavelength in a range of 0.4 μm to 15 μm.

18. The apparatus of claim 1, further comprising:
a processer arranged and designed to acquire attenuated intensities of the first light beam and the second light beam detected by the at least one detector and determine concentration of at least one component in the sample.

19. The apparatus of claim 1, wherein the at least one optical property is optical path length.

20. The apparatus of claim 1, wherein the at least one optical property is incident angle.

21. The apparatus of claim 1, wherein the at least one optical property is a number of total internal reflections at the interface.

22. A method for measuring a sample, comprising:
arranging the sample to be in direct contact with at least one face of a crystal;
producing and directing a first light beam and a second light beam into the crystal, such that the first light beam and the second light beam are totally internally reflected at an interface between the crystal and the sample, and such that the first light
beam travels along a first optical path in the crystal and the second light beam travels along a second optical path in the crystal, with the first optical path being different from the second optical path in at least one optical property; and
detecting the first light beam and the second light beam which have been totally internally reflected at the interface.

23. The method of claim 22, wherein directing the first light beam and the second light beam into the crystal includes directing the first light beam and the second light beam to have at least one of different incident angles at the interface or a different number of internal reflections within the crystal.

24. The method of claim 22, further comprising:
determining a difference in absorption between the first light beam and the second light beam; and
calculating at least one property of the sample based at least partially on the difference in absorption.

25. The method of claim 24, further comprising measuring a refractive index of the sample using the first light beam and the second light beam.

26. The method of claim 25, wherein:
the first light beam is totally internally reflected at the interface between the crystal and the sample at a first incident angle and the second light beam is totally internally reflected at the interface between the crystal and the sample at a second incident angle; and
measuring the refractive index of the sample using the first light beam and measuring the refractive index of the sample using the second light beam includes comparing an absorption of the first light beam and second light beam relative to the first incident angle and second incident angle.

27. The method of claim 25, wherein measuring a refractive index of the sample using the first light beam includes:
altering a first incident angle of the first light beam at the interface, and comparing an absorption of the first light beam and second light beam relative to the first incident angle and second incident angle.
